(19) United States
(12) Patent Application Publication
(10) Pub. No.: US 2016/0185347 A1
(43) Pub. Date: Jun. 30, 2016

(54) METHOD FOR ASSESSING THE RISK OF COLLISION AT AN INTERSECTION

(71) Applicants: RENAULT S.A.S., Boulogne-Billancourt (FR); INRIA - INSTITUT NATIONAL DE LA RECHERCHE EN INFORMATIQUE ET EN AUTOMATIQUE, Le Chesnay (FR)

(72) Inventors: Stephanie Lefevre, Cugnaux (FR); Javier Ibanez-Guzman, Raizeux (FR); Christian Laugier, Montbonnot-Saint-Martin (FR)

(21) Appl. No.: 14/432,273

(22) PCT Filed: Sep. 24, 2013
(86) PCT No.: PCT/FR2013/052218

§ 371 Date: Mar. 30, 2015

(30) Foreign Application Priority Data
Oct. 5, 2012 (FR) 1259493

(51) Int. Cl. B60W 30/095; G01S 19/42

(52) U.S. Cl. CPC B60W 30/0953; G01S 19/42; B60W 30/0956; B60W 2400/00

(57) ABSTRACT

The invention relates to a method for assessing the risk of collision between a first vehicle approaching an intersection and at least one second vehicle driving through said intersection, said first vehicle being provided with a measurement means and a computing means. The method according to the invention is mainly characterised in that same includes the following steps: a step of determining the respective positions of said first vehicle and each second vehicle, a step of estimating the intentions of the driver of said first vehicle and of each second vehicle, a step of estimating the need for the first vehicle and for each second vehicle to stop in accordance with the results provided by the two preceding steps and the traffic rules applicable to said intersection, and a step of estimating the risk of collision between the first vehicle and each second vehicle.

The invention relates to a method for assessing the risk of collision at an intersection.

Intersections are the most hazardous zones in the road network. By way of example, in 2004, 43% of accidents in Europe occurred at an intersection. These are also particularly anxiety-inducing zones, above all for older drivers, who sometimes have difficulty in analyzing the scene and taking a decision that is appropriate to the context of the situation. There is accordingly a considerable interest in developing safety systems with the ability accurately to estimate the risk of a collision at an intersection. Such systems may be utilized to increase the situational awareness of the driver as he approaches and then drives through an intersection, and they may thus reduce the stress caused by the presence of said intersection and improve safety in these zones.

The technical problem may be summarized as follows. A vehicle accumulates over time:
information concerning its status by means of its proprioceptive sensors, for example a GPS (Global Positioning System) navigation device or data transmitted on its CAN (Control Area Network) bus,
and information concerning its environment,
   via its on-board exteroceptive sensors, for example a camera or a radar, and/or
   via a communication link with the other vehicles and/or with communication modules that are integrated with the road infrastructure, for example a communication standard of type IEEE 802.11p.

The vehicle likewise has a static digital environmental map, which may take many different forms, for example a 2D map of the road network or a cloud of 3D points for the environment. This map contains information relating to the context, for example to the roads, to the traffic lanes, as well as to the applicable rules at each intersection, for example the speed limit and/or the presence of a traffic sign.

In order to estimate the risk of a collision at an intersection, it is therefore necessary to combine all this information and data in space and in time, in order to reconstruct the real situation and thus to assess the potential hazards.

However, a problem that is often encountered when adopting this approach is the unreliability of this data and this information, clue in particular to measurement errors that are inherent in the sensors, to localization errors, and to map errors. Furthermore, the intersections remain complex zones in which the evolution of a vehicle over time is more dependent on the intentions of the driver than on the physical characteristics of the vehicle, thereby making the interpretation of the data difficult and subject to numerous uncertainties.

Generally, in order to estimate the risk of a collision at an intersection, the proposed methods are based on physical models, which may be dynamic or kinematic, of the vehicles intended to predict their future trajectories. The risk is thus calculated as a function of the occurrence of a collision on these future trajectories. This type of method exhibits two limitations:
it is only applicable to collisions in the short term, because the physical models are only valid in the short term. In fact, in order to be capable of predicting the trajectories in a reliable manner in the longer term, it would be necessary to consider the situation on a higher level, for example by incorporating the intention of the drivers to maneuver and by taking account of the context, for example the geometry and the topology of the intersection, as well as the traffic rules.
it is costly in terms of computation time, because of the need to predict potential trajectories for all the vehicles that are present at the intersection, and the need to detect points of intersection between these trajectories, the length of this computation time being incompatible with the real time constraints of the safety-related applications.

Other more comprehensive methods, such as the method described in patent application US2012/0016581, are based on the consideration of the intention of the driver on approaching the intersection, by assuming, for example, that he will turn to the right or to the left, or that he may continue straight ahead. The assessment of the potentially hazardous situations is then undertaken by associating this intention with the prediction of the trajectories of all the vehicles that are present at the intersection, and by assessing the points of intersection of these trajectories. Although it is more comprehensive and more accurate than the aforementioned methods, this method still consumes a great deal of computation time and does not appear to be any more suited to the instantaneous implementation of safety-related applications.

The methods for assessing the risk of collision at an intersection according to the invention propose a rigorous and precise diagnosis with regard to the assessment of said risk, while performing a shortened calculation phase, which is entirely compatible with the real time constraints of the safety-related applications. In other words, said methods combine quality and performance with an improved speed of execution.

The invention has as its object a method for assessing the risk of collision between a first vehicle as it approaches an intersection and at least one second vehicle as it drives through said intersection, said first vehicle being provided with a measurement means and a computing means.

The principal characterizing feature of a method according to the invention is that it comprises the following steps:
a step of determining the respective positions of said first vehicle and of said second vehicle,
a step of estimating the intentions of the driver of said first vehicle and of said second vehicle, with regard to stopping or not stopping on entering the intersection and-with regard to maneuvering, in order to estimate the direction that each of said drivers intends to take on leaving said intersection,
a step of estimating the need for the first vehicle and for said second vehicle to stop in accordance with the results provided by the two preceding steps and the traffic rules that are applicable at said intersection,
a step of estimating the risk of collision between the first vehicle and said second vehicle, said estimation being based on a comparison between the intention of each vehicle to stop and the need for them to stop.

Such a method makes it possible to estimate a risk of collision by the first vehicle with at least one second vehicle, without being obliged to assess the potential trajectories of said vehicles, and to determine their point of intersection. This method thus avoids the use of excessively lengthy and excessively complicated calculations, which may constitute sources of error, and it is perfectly adapted to the real time constraints of the safety-related applications. It is assumed that the first vehicle is the source vehicle, and that it is equipped with means of measurement and means of calculation for implementing the various steps in the method according to the invention. The expression “second” is used to distinguish the first vehicle from the other vehicles which drive through the intersection. The expression “drive” likewise signifies that the second vehicle may be entering the intersection or may be stationary at said intersection, or that it may be exiting therefrom on a designated traffic lane. The second vehicle may also be situated on the same traffic lane providing access to the intersection as that on which the first vehicle is present, said second vehicle being positioned in front of said first vehicle. The traffic rules that are applicable at said intersection may be indicated by any type of traffic signs, or by traffic lights. It is assumed that such a method is controlled by an on-board computer, for example a central processor unit for managing all the electrical or electronic equipment of the vehicle, said computer having the appropriate software.

Advantageously, the traffic rules that are applicable at said intersection are communicated to the first vehicle by at least one means of information to be selected from a static digital environmental map, a communication between the first vehicle and communication modules situated on the infrastructure, and exteroceptive sensors.

Preferentially, the applicable traffic rules are indicated by at least one means to be selected from a traffic sign and by traffic lights, said rules providing at least one piece of information to be selected from an authorized speed limit at the intersection, a stop sign, a do not enter sign and a yield sign.

Preferentially, the assessment of the risk of collision corresponds to the calculation of the probability that one of the vehicles does not have the intention to stop when it should. By way of example, the risk of collision is in fact significant if a second vehicle that is required to come to a halt at the intersection, because of the presence of a stop sign, disregards this stop sign by continuing to move at a reduced speed.

Advantageously, the step of determining the respective positions of the first vehicle and of said second vehicle is complemented by a step of determining at least one supplementary parameter concerning the first vehicle and said second vehicle, to be selected from the orientation of said vehicles, their speed and the actions of the driver on the controls of the vehicle. This list is not exhaustive and may be complemented by other parameters, which may be available and which could provide supplementary details concerning the status of the vehicles that are present. By way of example, the actions of the driver on the controls may be represented by the application of pressure to the brake pedal or the accelerator pedal.

Advantageously, the step of determining the positions of the first, vehicle and of said second vehicle, as well as the step of determining at least one supplementary parameter, are performed by means of proprioceptive and exteroceptive measurement sensors that are carried on the first vehicle and/or by means of a wireless communication link, between the vehicles. It should be noted that the proprioceptive sensors are incorporated into the first vehicle and that they provide information concerning the actual status of said vehicle, and that the exteroceptive sensors are also carried in the first vehicle and that they provide information concerning each second vehicle. The wireless communication link permits the exchange of information between the vehicles and/or between the vehicles and communication modules that are present on the infrastructure. For example, the IEEE 802.11p communication standard may be utilized.

Preferentially, the proprioceptive sensors comprise at least one sensor to be selected from, a navigation device of the GPS (Global Positioning System) type and data transmitted via a bus of the CAN (Control Area Network) type. This list is not exhaustive, and it may, in particular, incorporate other types of navigation device with different technologies.

Preferentially, the exteroceptive sensors comprise at least one sensor to be selected, from an on-board camera, a radar and a laser.

Advantageously, a method for the assessment of the risk according to the invention is controlled by a central processor unit carried in the first vehicle. The central processor unit controls all the electrical and electronic equipment that is present in a vehicle. All that is required is to provide it with the appropriate software, taking into account the different steps in said method, in order to be able to control said steps and to provide an accurate diagnosis of the risk of collision between the first vehicle and each second vehicle.

Advantageously, the method comprises a step of taking a decision with the aim of influencing the driving behavior of the vehicle in order to adapt it to the detected risk. In fact, one of the key benefits of a method of assessment according to the invention is a modification to the driving behavior of the vehicle with a view to making the vehicle as well as the occupants of said vehicle safe. The modification may be achieved by means of an automatic action on the controls of the vehicle, or by means of a message addressed to the driver of the vehicle. This message may take the form of a signal to be selected from a visual, acoustic or haptic signal.

A method for the assessment of the risk according to the invention offers the advantage of being rapid, precise and therefore perfectly compatible with the real time constraints associated with the safety-related applications. In other words, if a situation of danger on approaching an intersection is detected by this method, an advanced driver assistance system of the ADAS type may, for example, proceed to perform an automatic braking operation. In addition, by considering the intentions of the drivers rather than the trajectory of the vehicles, a method according to the invention permits a better analysis of the scene and a more reliable prediction of the collisions in the long term. Finally, a method according to the invention has the advantage of being based on a probabilistic approach, thereby permitting account to be taken of any inaccuracies in the input data and in the interpretation of these data.

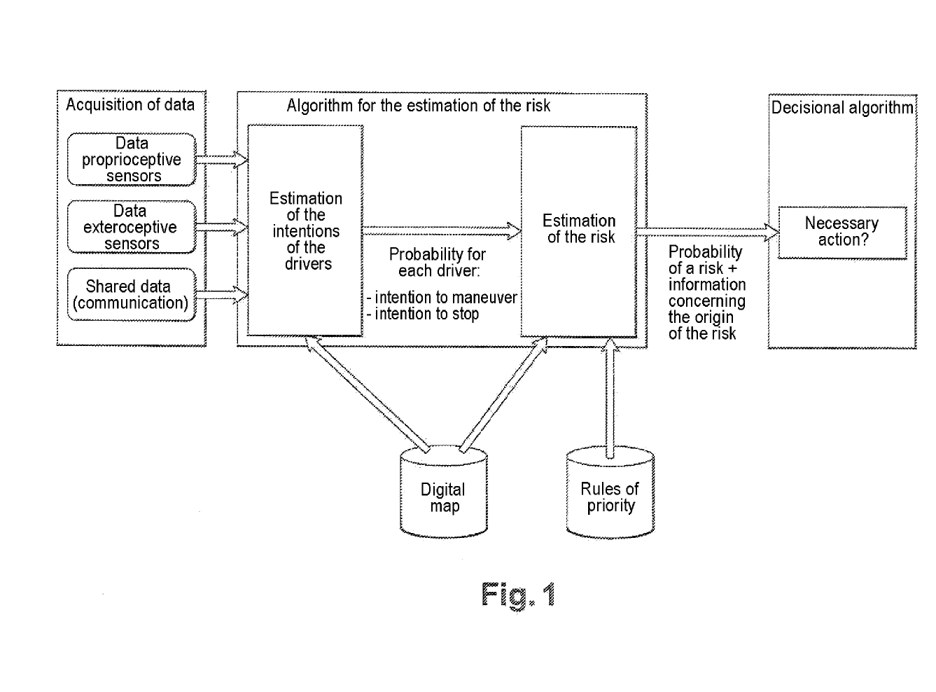

A detailed description of a preferred embodiment of a method for the assessment of the risk of collision between two vehicles at an intersection is given below with reference to FIGS. 1 to 3.

FIG. 1 is a synoptic view detailing the different, steps in a method according to the invention,

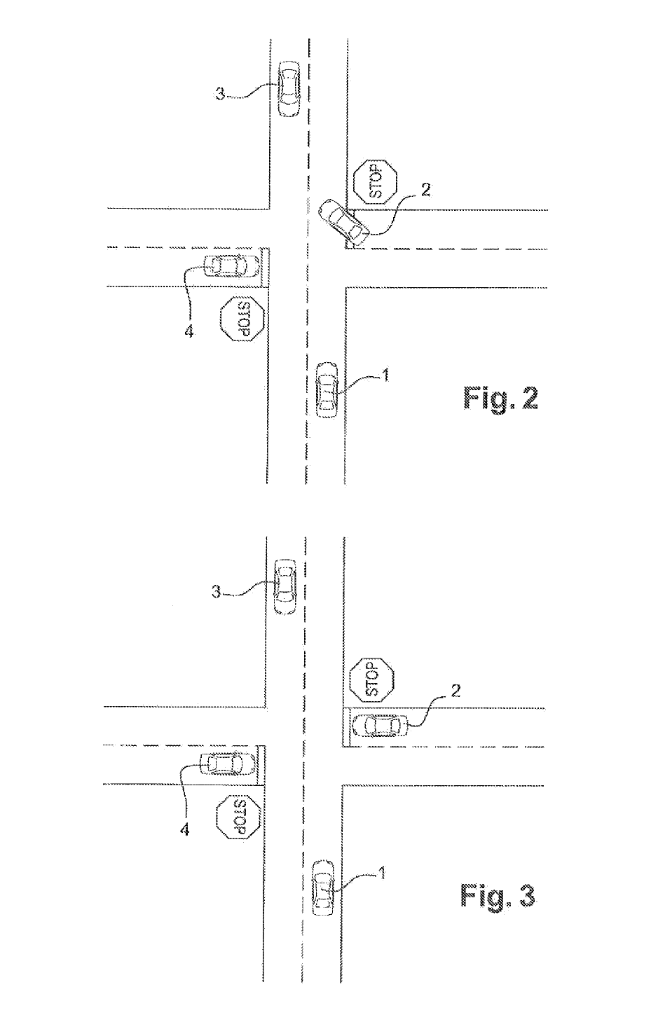

FIG. 2 is a schematic view of a first situation at an intersection,

FIG. 3 is a schematic view of a second situation at an intersection.

It is assumed that a method for the assessment of the risk according to the invention is implemented in the first vehicle by the use of means of measurement and means of calculation and is controlled by a central processor unit, which is a central device for managing the electrical or electronic equipment of the vehicle.

Such a method for assessing the risk of collision between a first vehicle and at least one second vehicle driving through an intersection, for example for all vehicles driving at a distance of less than 500 m from the intersection and on a traffic lane providing access to said intersection, comprises the following steps:
a step of determining the respective positions of said first vehicle and of each second vehicle, and the different parameters making it possible to provide information on the status of each of said vehicles,
a step of estimating the intentions of the driver of said first vehicle and of each second vehicle, with regard to stopping or not stopping on entering the intersection and with regard to maneuvering, in order to estimate the direction that each of said drivers intends to take on leaving said intersection,
a step of estimating the need for the first vehicle and for each second vehicle to stop in accordance with the results provided by the two preceding steps and the traffic rules that are applicable at said intersection,
a step of estimating the risk of collision between the first vehicle and each second vehicle, in accordance with the results provided by the two preceding steps, said estimation being based on a comparison between the intention of each vehicle to stop and the need, for them to stop,
a step of taking a decision with the aim of acting on the driving behavior of the vehicle in order to adapt it to the detected risk. This decision may result in an automatic action on the controls of the vehicle, or in a message addressed to the driver of the vehicle. This message may take the form of a signal to be selected from a visual, acoustic or haptic signal. The controls of the vehicle include, for example, the status of the flashing turn indicators, the accelerator pedal, the brake pedal and, if appropriate, the clutch pedal and the engaged gearbox ratio.

With reference to FIG. 1, the step of determining the respective positions of said first vehicle and of each second vehicle, and the different parameters making it possible to provide information on the status of each of said, vehicles, consists of a data acquisition step performed by means of proprioceptive sensors, exteroceptive sensors and shared data. This data acquisition step permits the first vehicle to accumulate over time information concerning its own status and its static and dynamic environment. The number of sensors and their type is not restricted, the only constraint being that said sensors must provide at least, one measure of the position of the first vehicle and of each second vehicle. All supplementary information providing information concerning the status of each vehicle is useful, however, as it will lead to a better estimation of the intentions of the drivers. By way of example, the proprioceptive sensors may be constituted by a navigation device of the GPS type, or by data transmitted on a CAN bus. The exteroceptive sensors may be represented, for example, by a camera and/or a radar and/or a laser. The shared data may be obtained thanks to a communication link with the other vehicles and/or a communication link with communication modules that are integrated in the road infrastructure, for example a communication standard of type IEEE 802.11p. In addition to the position of each vehicle, other parameters, for example the orientation in space of said vehicles, their speed and the actions of the driver on the controls of the vehicle, may constitute vital sources of information which will enable an assessment to be made of the intention of each driver at the intersection.

Thanks to the information and the data collected in the preceding step, the method according to the invention implements a step of estimating the intentions of the driver of said first vehicle and of each second vehicle, with regard to stopping or not stopping on entering the intersection and with regard to maneuvering, in order to estimate the direction that each of said drivers intends to take on leaving said intersection. In fact, it is important to know if a vehicle intends to stop or not to stop at an intersection and the direction that it intends to take once it arrives at the intersection, in order to be able to assess the risk of collision. The first step of data acquisition thus permits the intention of each driver to stop or not to stop at the intersection to be anticipated, and the direction that he wishes to take on leaving the intersection to be known.

The step of estimating the need for the first vehicle and for each second vehicle to stop is performed in accordance with the results provided by the two preceding steps and the traffic rules that are applicable at said intersection. The traffic rules that are applicable at the intersection may be indicated by-traffic signs, for example a stop sign, a do not enter sign, a yield sign or an authorized maximum speed limit, and/or by traffic lights. These traffic rules that are applicable at said intersection are communicated to the first vehicle by a means of information such as a static digital environmental map, a communication between the first vehicle and communication modules situated on the road infrastructure, and exteroceptive sensors such as a radar or an on-board camera.

The step of estimating the risk of collision between the first vehicle and each second vehicle is performed in accordance with a comparison between the intention of each vehicle to stop and the need for them to stop.

The intention of the drivers is estimated by combining in a probabilistic manner the data that are available concerning the vehicles and the context, thereby permitting account to be taken of the inaccuracies in the data and in the interpretation of these data. This step enables a semantic description of the scene to be arrived at, in particular by answering the following question: Who has the intention to do what, and with what probability.

Probabilistic models of the gap acceptance already exist in the literature, and these can be used to calculate the probability that a vehicle without priority will have sufficient time to execute its maneuver before the arrival of a vehicle having priority. By combining these models with the traffic rules that are applicable at the intersection, the approach is to estimate in a probabilistic manner whether a vehicle should or should not stop at the intersection.

By taking as an example a situation in which a first vehicle A is approaching an intersection of the yield type, the estimation of the need for this vehicle to stop is defined as follows:
1. Projection of the position of vehicle A until the time t_{A} at which it arrives at the entry to the intersection. A model of the “constant speed” type may be used for this purpose, for example.
2. Perform the same operation for all the second vehicles B having priority in relation to vehicle A. In other words, repeat the projection of the position of each vehicle B having priority over vehicle A, until the time t_{B} at which it arrives at the entry to the intersection, A model of the “constant speed” type may likewise be used for vehicles B.
3. Identify the shortest time interval available to vehicle A in which to carry out its maneuver before the arrival of each priority vehicle B, by comparing the times t_{A} and t_{B} for each priority vehicle B.
4. The need for vehicle A to stop is calculated as the probability that the time interval calculated in the preceding step will not be sufficient to carry out the maneuver. A probabilistic model of the gap acceptance may be used for this purpose.

Finally, a method for assessing the risk of collision incorporates a step of taking a decision with the aim of acting on the driving behavior of the vehicle in order to adapt it to the detected risk. By way of example, if the probability of collision calculated for the first vehicle is high, but if the speed of said vehicle remains constant as it approaches the intersection, an advanced driver assistance system may actuate the brake pedal automatically in order to bring the vehicle to a halt, or to reduce its speed considerably.

FIG. 2 illustrates an example of a hazardous scenario at an intersection. Vehicles 1 and 3 are approaching the intersection at a constant speed and have priority according to the signage. Vehicle 4 has stopped at the stop sign. Vehicle 2 has moved forward and is half-way onto the lane occupied by vehicles 1 and 3, and it is assumed that its speed is increasing.

### Acquisition of Data

The sensors provide data concerning the successive positions of the vehicles, and potentially information about their orientation, their speed, the status of their flashing turn indicator, etc.

### Algorithm for the Estimation of Risk

### Estimation of the Intentions of the Drivers

By combining the available information for the vehicles, for the geometry of the intersection and for the signage, a method according to the invention will make it possible to estimate in a probabilistic manner that the intention of drivers 1 and 3 is to drive through the intersection without stopping, that the intention of driver 4 is to yield to driver 3, and that the intention of driver 2 is to make a right turn without waiting.

### Estimation of the Risk

By comparing the estimated intentions with the traffic rules that are applicable at the intersection, a method according to the invention will make it possible to calculate the probability that the intentions of the drivers are in conflict with the rules governing priority. This probability will be low for drivers 1, 3 and 4, and high for driver 2 because he does not have sufficient time available to carry out his maneuver before the arrival of vehicle 1 at the intersection.

### Decision Algorithm

A decision is necessary because the probability that vehicle 2 represents a danger is considerable. The action to be taken will depend on a number of factors: the value of the risk, the configuration of the situation by assessing whether or not there is a risk of an imminent collision, the speed of the vehicles concerned, the warning means or control means available on the vehicle, for example a visual, acoustic or haptic warning device, or an actuator for the automatic braking elements of the vehicle.

FIG. 3 illustrates an example of a non-hazardous scenario at an intersection. Vehicles 1 and 3 are approaching the intersection at a constant speed and nave priority. Vehicles 2 and 4 have stopped at the stop sign.

### Acquisition of Data

This step takes place in exactly the same way as that described for the previous hazardous scenario.

### Algorithm for the Estimation of the Risk

### Estimation of the Intentions of the Drivers

In the present case, the method according to the invention will make it possible to estimate in a probabilistic manner that the intention of driver 2 is to yield to driver 1.

### Estimation of the Risk

The probability that the intentions of the drivers will be in conflict with the rules governing priority will be low for all the drivers.

### Decision Algorithm

No action is necessary because none of the vehicles represents a danger.

1. A method for assessing the risk of collision between a first vehicle as it approaches an intersection and at least one second vehicle as it drives through said intersection, said first vehicle being provided with a measurement means and a computing means, said method comprising the steps of:
determining the respective positions of said first vehicle and of said second vehicle,
estimating the intentions of the driver of said first vehicle and of said second vehicle, with regard to stopping or not stopping on entering the intersection and with regard to maneuvering, in order to estimate the direction that each of said drivers intends to take on leaving said intersection,
estimating the need for the first vehicle and for said second vehicle to stop in accordance with the results pro vided by the two preceding steps and the traffic rules that are applicable at said intersection,
estimating the risk of collision between the first vehicle and said second vehicle, said estimation being based on a comparison between the intention of the vehicles to stop and the need for them to stop.

2. The method as claimed in claim 1, wherein the information relating to traffic rules that are applicable at said intersection is communicated to the first vehicle by at least one means of information to be selected from a static digital environmental map, a communication between the first vehicle and communication modules situated on the infrastructure, and exteroceptive sensors.

3. The method of assessment as claimed in claim 1, wherein the applicable traffic rules are indicated by at least one means to be selected from a traffic sign and by traffic lights, and in that said rules provide at least one piece of information to be selected from an authorized speed limit at the intersection, a stop sign, a do not enter sign and a yield sign.

4. The method of assessment as claimed in claim 1, wherein the assessment of the risk of collision corresponds to the calculation of the probability that one of the vehicles does not have the intention to stop when it should.

5. The method of assessment as claimed in claim 1, wherein the step of determining the respective positions of the first vehicle and of said second vehicle is complemented by a step of determining at least one supplementary parameter concerning the first vehicle and each of the second vehicles, to be selected from the orientation of said vehicles, their speed and the actions of the driver on the controls of the vehicle.

6. The method of assessment as claimed in claim 5, wherein the step of determining the positions of the first vehicle and of said second vehicle, as well as the step of determining at least one supplementary parameter, are performed by means of proprioceptive and exteroceptive measurement sensors that are carried on the first vehicle and/or by means of a wireless communication link between the vehicles.

7. The method of assessment as claimed in claim 6, wherein the proprioceptive sensors comprise at least one sensor to be selected from a navigation device of the GPS type and data transmitted via a bus of the CAN type.

8. The method of assessment as claimed in claim 6, wherein the exteroceptive sensors comprise at least one sensor to be selected from an on-board camera, a radar and a laser.

9. The method of assessment as claimed in claim 1, wherein said method is controlled by a central processor unit carried in the first vehicle.

10. The method of assessment as claimed in claim 1, wherein said method further comprises a step of taking a decision with the aim of influencing the driving behavior of the vehicle in order to adapt it to the detected risk.
